(19) United States
(12) Patent Application Publication
(10) Pub. No.: US 2026/0175817 A1
(43) Pub. Date: Jun. 25, 2026

(54) MOTOR VEHICLE HAVING A CLEANING DEVICE AND AN ENVIRONMENTAL SENSOR

(71) Applicant: Webasto SE, Stockdorf (DE)

(72) Inventor: Magnus SVIBERG, Stockdorf (DE)

(21) Appl. No.: 19/425,020

(22) Filed: Dec. 18, 2025

(30) Foreign Application Priority Data
Dec. 20, 2024 (DE) 10 2024 139 303.3

(51) Int. Cl. B60S 1/08; B60S 1/52

(52) U.S. Cl. CPC B60S 1/0822; B60S 1/52

(57) ABSTRACT

A motor vehicle is disclosed having a vehicle window, a vehicle window wiper system for cleaning a field of view of the vehicle window, a vehicle roof which adjoins the vehicle window in a front and/or rear roof region, an environmental sensor which is arranged in a interior of the motor vehicle in a roof-side corner region of the vehicle window and which can sense a vehicle environment through a transparent region through the vehicle window, and a cleaning device which is arranged on the vehicle roof and is designed to clean the transparent region of the vehicle window. The transparent region of the vehicle window is situated at least partially outside the field of view of the vehicle window.

### CROSS-REFERENCE TO RELATED APPLICATION(S)

This application claims the benefit of German patent application no. 10 2024 139 303.3, filed on December 20, 2024, which is incorporated herein by reference in its entirety.

### TECHNICAL FIELD

The disclosure relates to a motor vehicle with a cleaning device and an environmental sensor. Furthermore, the invention relates to an autonomous motor vehicle.

### BACKGROUND

The integration of environmental sensors into autonomous and semi-autonomous vehicles, including lorries, is established in automotive technology. In particular, placing sensors of this type in the roof region of the vehicles and the use of cleaning systems for ensuring their functionality are known approaches. These sensors such as, for example, lidar sensors, radar sensors and (multi-)cameras play a central role in sensing and analysing the vehicle environment. By the evaluation of electromagnetic signals, they make it possible to create data models which are used to steer the vehicle. Roof modules which are called Roof Sensor Modules (RSM) frequently integrate a plurality of sensors of this type and therefore offer comprehensive sensing of the vehicle environment.

In order to optimize the sensor functionality, different cleaning systems are used. Known solutions comprise, for example, cleaning systems which clean both the transparent region of sensors placed in the vehicle roof and the windscreen or rear window. Systems likewise exist with movable cleaning nozzles, the position of which is controlled by the kinematics of movable sensors.

Despite these advances, the cleaning of sensors which lie outside the reach of conventional vehicle window wipers and look through the windscreen remains a challenge. Sensors of this type are often accessible only with difficulty, which makes the cleaning either extremely difficult or of technically highly complex design. Moreover, known solutions can entail aesthetic disadvantages which are problematic, in particular, in the creation of modern vehicle designs.

### SUMMARY

The present embodiments specify an improved, possibly also autonomously driving, motor vehicle. In particular, it is the object to provide a motor vehicle with an improved cleaning device which preferably improves both the technical and the aesthetic functionality of the cleaning device for environmental sensors in the motor vehicle.

The object is achieved by a motor vehicle with the features of the claims. Furthermore, the object is achieved by an autonomously driving motor vehicle with the features of the claims.

Advantageous embodiments of the invention are the subject matter of the dependent claims. All combinations of at least two features disclosed in the description, claims and/or the figures fall within the scope of the invention. It goes without saying that the comments made in respect of the motor vehicle refer in an equivalent way to the present autonomously driving motor vehicle, without being mentioned redundantly for the latter. It goes without saying here, in particular, that common linguistic rewording and/or an analogous replacement of respective terminology within the context of customary linguistic practice, in particular the use of synonyms which are supported by the generally recognized linguistic literature, are included by the present disclosure without being mentioned explicitly in their respective wording.

In the present case, a motor vehicle is claimed with a vehicle window, a vehicle window wiper system for cleaning a field of view of the vehicle window, a vehicle roof which adjoins the vehicle window in a front and/or rear roof region, an environmental sensor which is arranged in a interior of the motor vehicle in a roof-side corner region of the vehicle window and which can sense a vehicle environment through a transparent region through the vehicle window, and a cleaning device which is arranged on the vehicle roof and is designed to clean the transparent region of the vehicle window. The transparent region of the vehicle window is situated at least partially outside the field of view of the vehicle window.

In the present case, an autonomously driving motor vehicle is also claimed, in particular without a vehicle window wiper system, with a vehicle window, a vehicle roof which adjoins the vehicle window in a front and/or rear roof region, an environmental sensor which is arranged in a interior of the motor vehicle in a roof-side corner region of the vehicle window and which can sense a vehicle environment through a transparent region through the vehicle window, and a cleaning device which is arranged on the vehicle roof and is designed to clean at least the transparent region of the vehicle window.

As a result of the arrangement according to the invention of the cleaning device, it is also possible to effectively clean a transparent region or a part region of the vehicle window, through which the at least one environmental sensor looks. This is also possible, in particular, when the transparent region lies outside the field of view of the vehicle window, that is to say cannot be cleaned by the conventional cleaning systems or wiper systems of the vehicle window. This has not been possible up to now without problems in the prior art, since a vehicle window cleaning system as a rule does not clean the entire outer surface of a vehicle window, but rather merely a part region, the size of which is limited by the length and arrangement of windscreen wipers.

The invention makes an improved utilization of sensors with an extended field of view possible, as a result of which the efficiency and precision during the detection of environmental data is increased. At the same time, it affords advantages in the area of styling and layout, by a more appealing design and a harmonic integration of the components into the vehicle being made possible. As a result of an optimized arrangement and packaging of the sensors and associated systems, the space utilization or the installation space is additionally improved, which leads to a reduction in the package, weight and production costs. Moreover, the invention increases the robustness and stability of the overall construction, as a result of which the service life and reliability of the systems are increased. Overall, the improved design and styling do not only contribute to a higher functionality, but rather also to an aesthetic enhancement of the vehicle. The optimization of the layout and the installation space finally makes more efficient production and integration possible, as a result of which the overall costs of the system can be lowered further.

In the present case, the term “environmental sensor” is used synonymously with the term “sensor”. In the present case, the term “motor vehicle” is used anonymously with the term “vehicle”. The vehicle window can comprise, for example, a windscreen or a rear window. The present invention can likewise be used in the area of a windscreen and in the area of a rear window of a vehicle.

The field of view of the vehicle window denotes the region in which the windscreen or rear window can be looked through and which is used by the driver and passengers to perceive the environment of the vehicle.

The roof region which adjoins the vehicle window comprises that part of the vehicle roof which immediately adjoins the upper edge of the vehicle window and is, for example, an interface to the vehicle body.

The interior of the motor vehicle describes that region within the vehicle body which is available to the occupants and typically comprises the passenger compartment and the technical equipment such as dashboard, seats and operating elements.

The roof-side corner region of the vehicle window relates to the outer corners of the windscreen which adjoin the roof of the vehicle, and is a preferred region for the integration of sensors.

The transparent region of the environmental sensor describes that region of the windscreen which lies in the corner region and through which an environmental sensor such as, for example, a lidar or camera sensor detects its environment, wherein this region is preferably defined by transparent materials, in order to ensure an undisrupted function of the environmental sensor.

The wording “the transparent region of the vehicle window is situated at least partially outside the field of view of the vehicle window” means that that region of the window, through which an environmental sensor looks, does not lie completely in the field of view which is provided for the driver or the passengers for perceiving the vehicle environment. A part of the transparent region can therefore be situated in a region which is not utilized actively for looking outwards, for example on an edge or corner region of the vehicle window which lies outside the primary line of sight.

In a further aspect, the cleaning device is arranged from the outside on the vehicle roof and is configured to clean the transparent region of the vehicle window from outside the motor vehicle.

The cleaning device is attached on the outside to the vehicle roof and is designed specifically to clean the transparent region of the vehicle window from outside the vehicle. This arrangement makes effective cleaning possible, without the function of the cleaning device being restricted by elements in the interior of the vehicle. The cleaning device is therefore fastened to the outside of the vehicle roof and is configured to clean the transparent region of the vehicle window from the outer side of the vehicle.

In a further aspect, the environmental sensor is arranged in the interior of the motor vehicle in the corner region behind the vehicle window or directly on the vehicle window or is integrated at least partially into the vehicle window.

The wording “arranged in the corner region behind the vehicle window” means that the environmental sensor is positioned in the interior of the vehicle in the vicinity of the outer corners of the vehicle window, but on the inner side of the window, that is to say behind the latter. “Positioned directly on the vehicle window” means that the sensor is attached as closely as possible to the vehicle window, without being integrated directly into the latter, for example to a holder or a housing which adjoins the window. “Integrated at least partially into the vehicle window” means that the environmental sensor is incorporated into the structure of the window, wherein either the entire sensor or parts thereof such as, for example, the lens or a covering element is/are embedded into the vehicle window. This arrangement makes flexible placing of the sensor possible, in order to ensure an optimum functionality and integration into the vehicle design. The environmental sensor is therefore preferably arranged in the interior of the vehicle in the region of the corners behind the vehicle window, is positioned directly on the vehicle window or is embedded in parts into the vehicle window.

In a further aspect, the transparent region of the vehicle window is situated completely outside the field of view of the vehicle window and cannot be cleaned by the vehicle window wiper system.

The wording “transparent region of the vehicle window completely outside the field of view” means that the region of the vehicle window, through which the environmental sensor looks and senses its environment, does not lie in the region which is provided for the driver or the passengers to look at the vehicle environment. This transparent region is therefore situated outside the primary field of view which is usually relevant for manually steering the vehicle, and is therefore not covered or cleaned by the window wiping function.

It is preferred in a further aspect that the cleaning device has at least one cleaning nozzle which is placed onto the vehicle roof in the roof-side corner region, wherein the at least one cleaning nozzle is oriented onto the transparent region in order to clean the transparent region.

The wording that the “cleaning device has at least one cleaning nozzle” means that the cleaning device is designed in such a way that it comprises at least one cleaning nozzle which serves to dispense cleaning liquid or a cleaning gas, more generally a cleaning fluid, in a targeted manner. The cleaning nozzle is preferably an integral constituent part of the cleaning device and assumes the task of cleaning the desired region. The wording “is oriented onto the transparent region” means that the cleaning nozzle is preferably positioned or set in such a way that the dispensed cleaning jet or the cleaning fluid is directed directly onto the transparent region of the environmental sensor, in order to ensure effective cleaning of this region.

It is preferred in a further aspect that the cleaning device has at least one cleaning nozzle which can be adjusted in the roof-side corner region from outside the motor vehicle at least between a rest position and a cleaning position, wherein the at least one cleaning nozzle is oriented onto the transparent region in order to clean the transparent region at least in the cleaning position.

It is preferred in a further aspect that the cleaning device has a drive and an adjusting mechanism, wherein the drive is configured to adjust the at least one cleaning nozzle using the adjusting mechanism at least between the rest position and the cleaning position.

The cleaning device is therefore equipped with a drive which has the function of providing movements or forces in order to change the position of the at least one cleaning nozzle. Here, the drive can be of electric, pneumatic, hydraulic or mechanical configuration. The adjusting mechanism is preferably a mechanical device which is connected to the drive and converts these movements into a targeted displacement of the cleaning nozzle, with the result that the nozzle can be moved between different positions, such as the rest position in the cleaning position.

It is preferred in a further aspect that the adjusting mechanism is designed to tilt the at least one cleaning nozzle, for example about a pivot axis, or to move it, for example swing it out, from the rest position at least into the cleaning position by a complex (for example, rotational and translational) movement, and/or to adjust it at least partially in front of the transparent region or over the transparent region, as viewed in a viewing direction of the environmental sensor.

It is preferred in a further aspect that the cleaning device has a panel element which is designed to deflect an airstream and/or a headwind of the motor vehicle, in order in this way to increase a cleaning effect of the cleaning device.

The wording “panel element” means that the cleaning device comprises a preferably specifically designed component which is designed to direct or to block the air flow in a targeted manner. This panel element is preferably positioned and shaped in such a way that it is directly linked to the function of the cleaning device and assists its effectivity. The panel element can also serve as a flap or cover element or more generally as a covering.

The wording “to deflect airstream and/or a headwind of the vehicle” means that the panel element serves to deflect the airstream produced by the movement of the vehicle or an opposite headwind in such a way that it does not act directly on the cleaning nozzle or the region to be cleaned. This prevents the air flow from deflecting the cleaning fluid or impairing the cleaning action, which ultimately increases the efficiency and precision of the cleaning device.

It is preferred in a further aspect that the cleaning nozzle is arranged on the panel element, and can be adjusted with the panel element at least between the rest position, a middle position and the cleaning position, wherein the at least one cleaning nozzle is designed, furthermore, to clean the transparent region in the middle position.

The wording that the “cleaning nozzle is arranged on the panel element” means that the cleaning nozzle is connected physically to the panel element or is mounted on it. This arrangement makes a coordinated movement of the cleaning nozzle together with the panel element possible, as a result of which precise positioning and function are ensured.

The wording “middle position” describes a position of the cleaning nozzle and the panel element which is situated between the rest position (inactive state) and the cleaning position (active cleaning). In this middle position, the cleaning nozzle is moved into a position which is suitable for effectively cleaning certain regions such as the transparent region of the sensor.

The wording “designed to clean the transparent region in the middle position” means that the cleaning nozzle is designed and positioned in such a way that it is (also) oriented directly or indirectly on to the transparent region of the sensor in the middle position. This ensures that the cleaning liquid is dispensed precisely and effectively onto this region, in order to remove dirt or other disturbances and to make an undisrupted function of the sensor possible.

In one preferred embodiment, the cleaning device has at least one fluid line and/or at least one fluid line connector and/or at least one fluid line adapter and/or at least one valve and/or at least one pump and/or at least one compressor and/or at least one electric connector line and/or at least one fluid line splitter. The list made here is not to be understood as conclusive, with the result that in principle other components which are utilized for cleaning a transparent region are also at least implicitly included.

In one preferred embodiment, the at least one environmental sensor comprises a lidar sensor and/or a camera sensor and/or a multi-camera sensor and/or an ultrasonic sensor and/or an antenna and/or an antenna module. Other environmental sensors are also conceivable, with the result that the list mentioned here is not to be understood as restrictive.

The motor vehicle preferably comprises a motor vehicle body and is characterized in that the vehicle roof is configured as a roof sensor module which forms a preassembled structural unit which is arranged on the motor vehicle body, in particular on at least one body spar of the motor vehicle body.

A roof sensor module of this type can fundamentally be arranged at any desired location of a motor vehicle and can be designed for different purposes.

The motor vehicle can preferably be a passenger motor vehicle, a lorry, a transport vehicle, a rail vehicle, an autonomously or semi-autonomously driving vehicle, a passenger transport vehicle, an infantry vehicle or the like.

It goes without saying that the embodiments and exemplary embodiments which are mentioned above and are still to be explained in the following text can be configured not only individually but rather also in any desired combination with one another, without departing from the scope of the present invention. It likewise goes without saying that the embodiments and exemplary embodiments which are mentioned above and are still to be explained in the following text refer in an equivalent or at least similar way to all implementations of the invention, without being mentioned separately in each case.

### BRIEF DESCRIPTION OF DRAWINGS

Embodiments of the invention are shown diagrammatically in the drawings and will be explained by way of example in the following text. In the drawings:

FIG. 1 shows a diagrammatic view of one exemplary embodiment of a motor vehicle,

FIG. 2 shows a diagrammatic detailed view of one exemplary embodiment of a motor vehicle,

FIG. 3 shows a diagrammatic detailed view of one exemplary embodiment of the motor vehicle,

FIGS. 4A-B each show a diagrammatic detailed view of one exemplary embodiment of a motor vehicle,

FIGS. 5A-C each show a diagrammatic detailed view of one exemplary embodiment of a motor vehicle,

FIGS. 5A-C each show a diagrammatic detailed view of one exemplary embodiment of a motor vehicle,

FIG. 6A shows a diagrammatic detailed view of one exemplary embodiment of a motor vehicle,

FIGS. 6B-C each show a diagrammatic view of a cleaning device,

FIGS. 7A-C each show a diagrammatic detailed view of one exemplary embodiment of a motor vehicle (on the left) and a respective associated sectional view (on the right),

FIG. 8 shows a diagrammatic sectional view of one exemplary embodiment of a motor vehicle, and

FIGS. 9A-C each show a diagrammatic view of a cleaning device.

### DETAILED DESCRIPTION

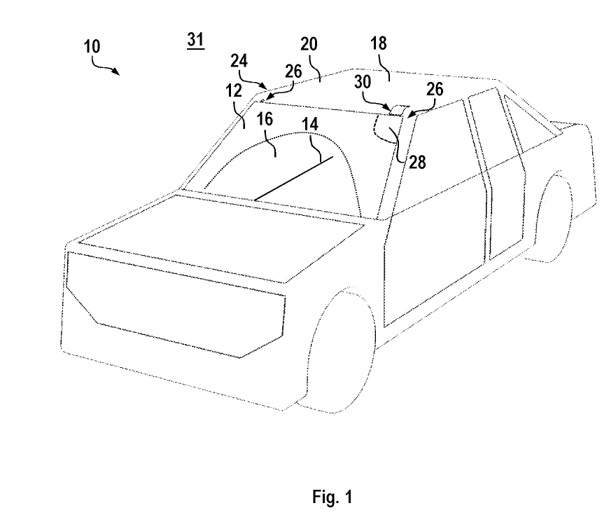

FIG. 1 shows a motor vehicle 10 with a vehicle window 12 and a vehicle window wiper system 14 for cleaning a field of view 16 of the vehicle window 14.

The statements also apply to an autonomously driving motor vehicle 10 which does not have a vehicle window wiper system.

Furthermore, the motor vehicle 10 comprises a vehicle roof 18 which adjoins the vehicle window 12 in a front and/or rear roof region 20. In the present case, the vehicle window 12 is a windscreen. The statements also apply to a rear window, however.

Furthermore, the motor vehicle 10 comprises an environmental sensor 22 which is arranged in an interior 24 of the motor vehicle 10 in a roof-side corner region 26 of the vehicle window 12, and which can sense a vehicle environment through a transparent region 28 through the vehicle window 14. The environmental sensor 22 is arranged in the interior 24 of the vehicle 10 in the corner region 26 behind the vehicle window 12 or directly on the vehicle window 12. As an alternative, the environmental sensor 22 is integrated at least partially into the vehicle window 12. The environmental sensor 22 senses a vehicle environment along or around a viewing direction 23. The environmental sensor 22 is fastened to the vehicle window 12, for example, by means of a sensor housing 25 starting from the interior 24 of the motor vehicle 10.

Furthermore, the motor vehicle 10 comprises a cleaning device 30 which is arranged on the vehicle roof 18 and is designed to clean the transparent region 28 of the vehicle window 12, wherein the transparent region 28 of the vehicle window 14 is situated at least partially outside the field of view 16 of the vehicle window 12. The cleaning device 30 is arranged on the vehicle roof 18 from outside or starting from a vehicle exterior 31, and is configured to clean the transparent region 28 of the vehicle window 12 from outside the vehicle 10. In the case of the figures, the transparent region 28 of the vehicle window 12 lies completely outside the field of view 16 of the vehicle window 12, with the result that the transparent region 28 cannot be cleaned by the vehicle window wiper system 14.

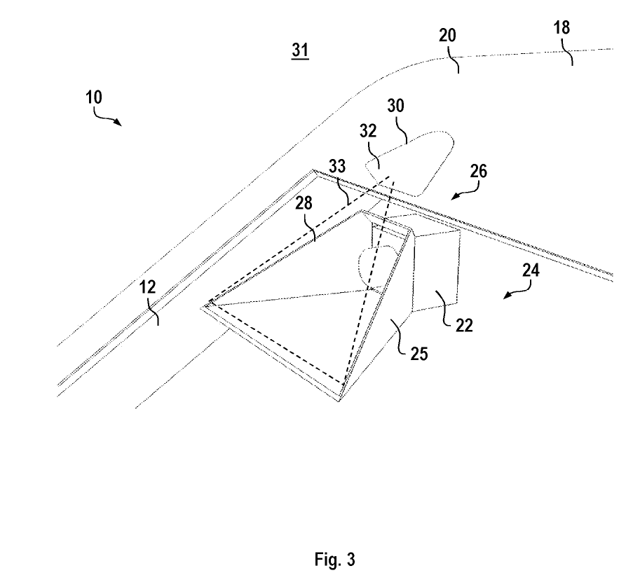

The cleaning device 30 has at least one cleaning nozzle 32 which, in the example of FIG. 3, is placed onto the vehicle roof 18 in the roof-side corner region 26. The cleaning nozzle 32 is designed to apply a cleaning fluid 33. The cleaning fluid can be liquid and/or gaseous, but can also have solid constituent parts. In this position for cleaning the transparent region 28, the at least one cleaning nozzle 32 is oriented onto the transparent region 28.

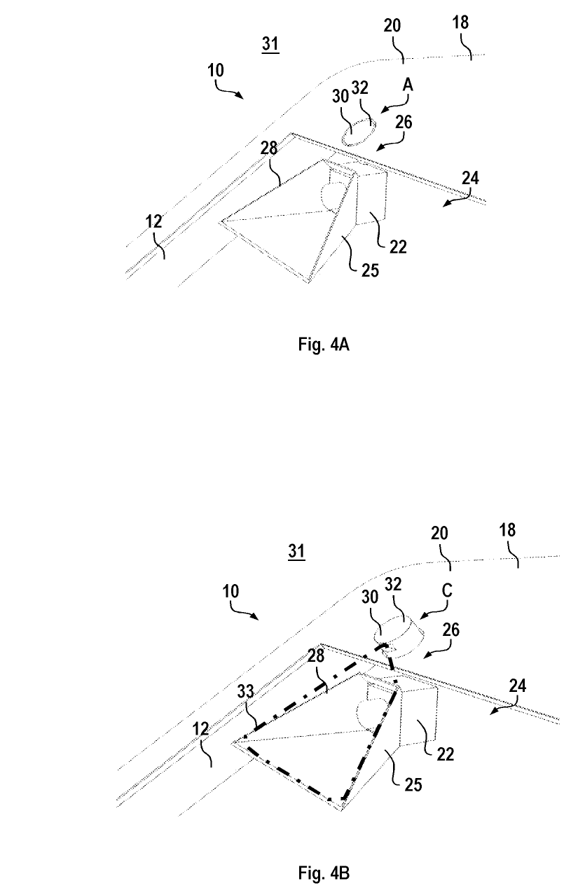

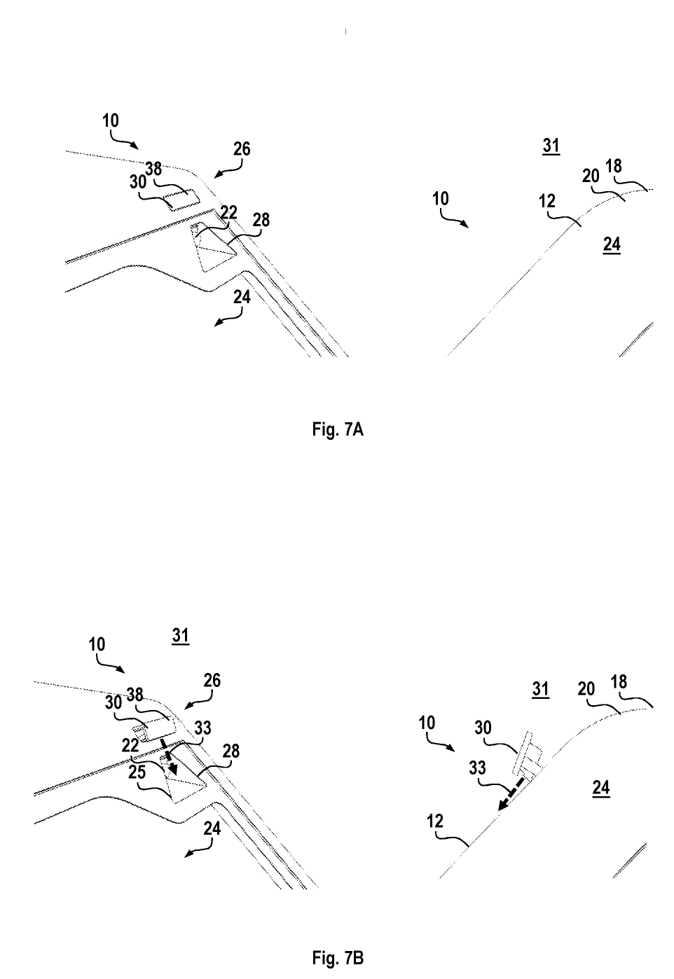

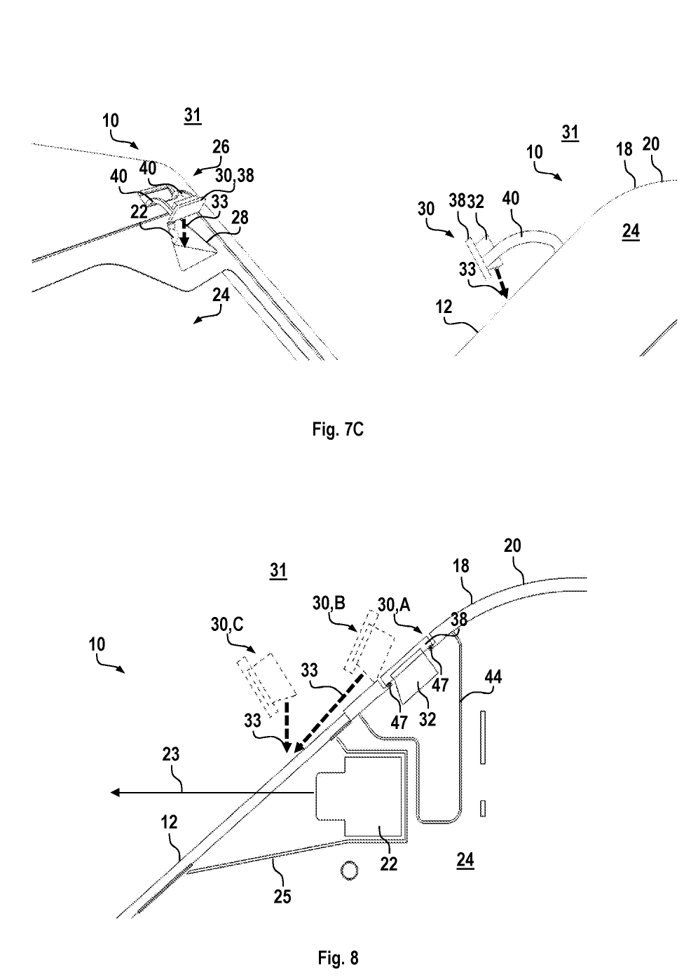

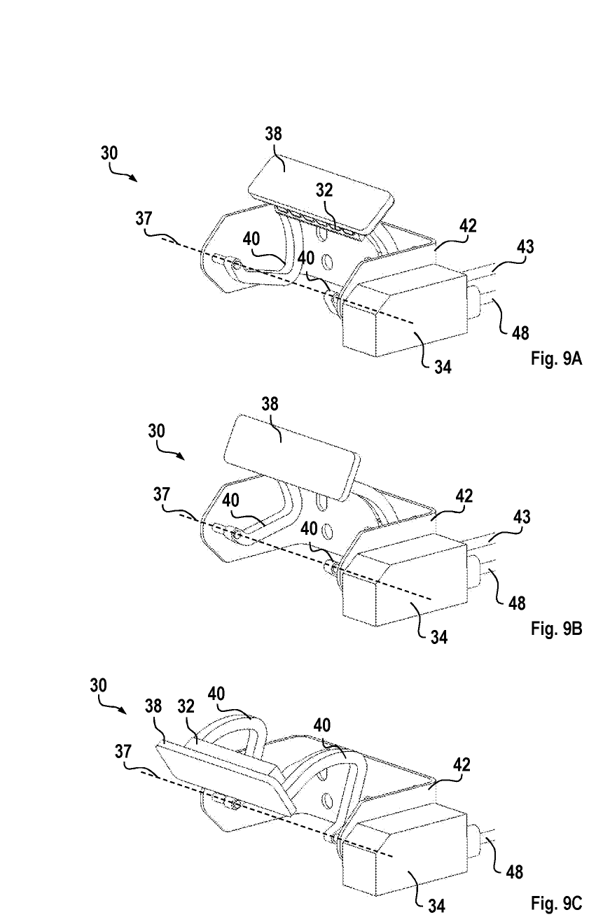

In FIGS. 4 to 9, the cleaning nozzle 32 can be adjusted at least between a rest position A and a cleaning position C, wherein the at least one cleaning nozzle 32 is oriented at least in the cleaning position C onto the transparent region 28 for cleaning the transparent region 28.

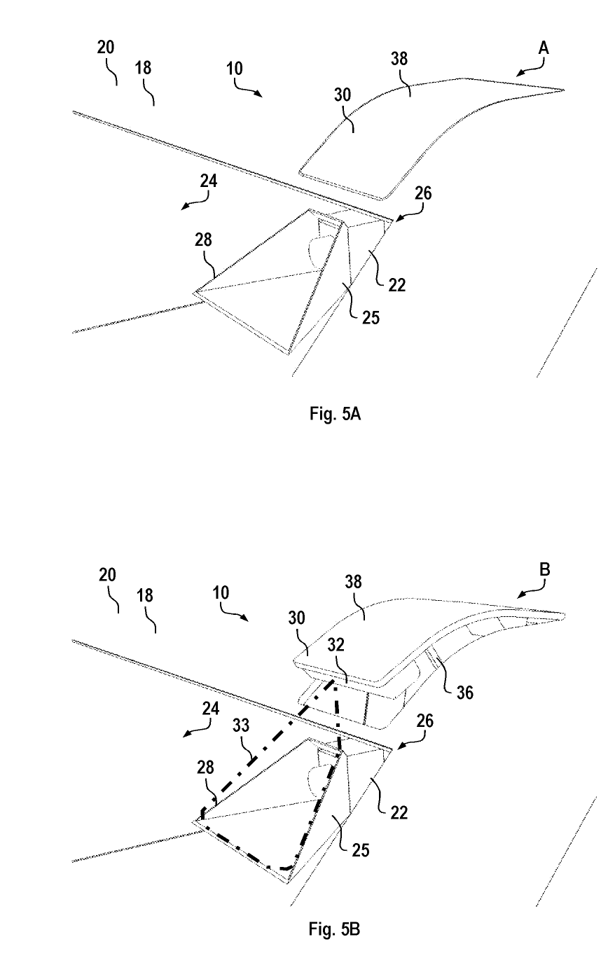

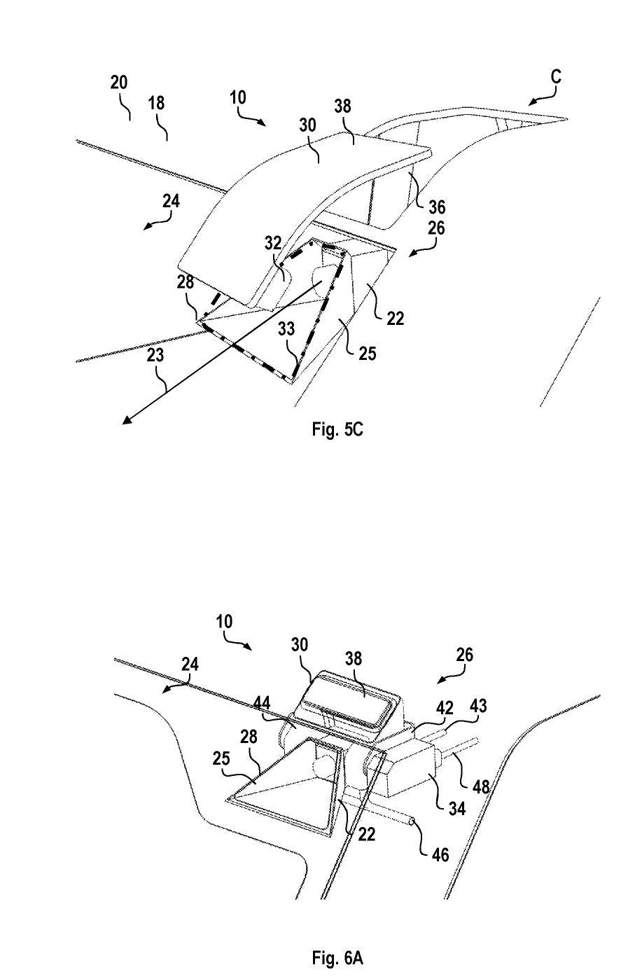

To this end, the cleaning device 30 has a drive 34 and an adjusting mechanism 36, wherein the drive 34 is configured to adjust the at least one cleaning nozzle 32 by the adjusting mechanism 36 at least between the rest position A and the cleaning position C. The adjusting mechanism 36 can be designed to tilt the at least one cleaning nozzle 32 (only), for example about a pivot axis 37, as is apparent by way of example from FIG. 5B. As an alternative, the adjusting mechanism 36 can also be designed to displace the at least one cleaning nozzle 32 from the rest position A into the cleaning position C by a complex (for example, rotational and translational) movement, for example to swing it out and/or to adjust it at least partially, as viewed in a viewing direction of the environmental sensor 22, in front of the transparent region 28 or over the transparent region 28, as can be gathered from FIGS. 5C, 7C and 8.

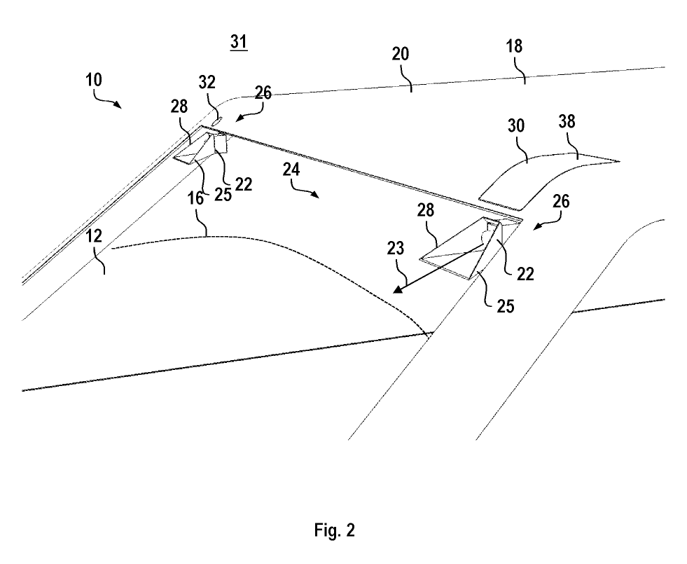

Furthermore, the cleaning device 30 can have a panel element 38 which is designed to deflect an airstream and/or a headwind of the vehicle 10, in order in this way to increase the cleaning effect of the cleaning device 30 (see FIGS. 1, 2 and 5-9).

The cleaning nozzle 32 can be arranged on the panel element 38, and can be adjustable with the panel element 38 at least between the rest position A, a middle position B and the cleaning position C. Here, furthermore, the at least one cleaning nozzle 32 is designed in the middle position B to clean the transparent region 28 of the vehicle window 12.

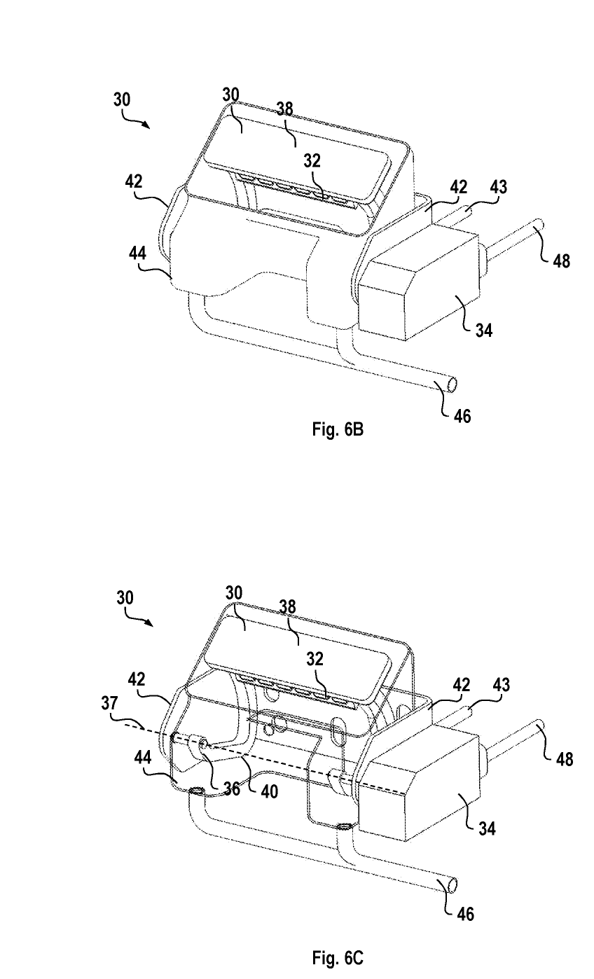

As is apparent, in particular, from FIGS. 6A-C, the panel element 38 can be fastened movably by a hinge 40 to a holding element 42, in particular a holding plate or a carrier plate, of the cleaning device 30. The panel element 38 is then controlled movably by the hinge 40 via the drive 34, for example an electric motor. The cleaning nozzle 32 is fastened directly to the panel element 38. The cleaning nozzle is attached to the vehicle 10 by way of example by way of a fluid line 43, in order to be supplied with cleaning fluid in this way. Furthermore, the cleaning device 30 has a fluid management reservoir 44. The fluid management reservoir 44 has a drain line 46 which ensures fluid management. Furthermore, the cleaning device 30 has a seal 47 which is arranged between the panel element 38 and the vehicle 10 and likewise ensures the fluid management. In this embodiment, the cleaning device 30 has three positions, namely the rest position A, the middle position B and the cleaning position C which defines an end position. Cleaning is possible in the middle position B and the cleaning position C positions. As an alternative or in addition, cleaning of the transparent region 28 can also be possible during the movement of the panel element 38 together with the cleaning nozzle 32 and/or during the movement of the cleaning nozzle 32.

FIGS. 6A-C and 9A-C show, furthermore, a connector 48 for electrical energy and controlling the cleaning device 30, for example the drive 34.

### LIST OF REFERENCE SIGNS

10 Motor vehicle

12 Vehicle window

14 Vehicle window wiper system

16 Field of view

18 Vehicle roof

20 Roof region

22 Environmental sensor

23 Viewing direction

24 Interior

25 Sensor housing

26 Corner region

28 Transparent region

30 Cleaning device

31 Vehicle exterior

32 Cleaning nozzle

33 Cleaning fluid

34 Drive

36 Adjusting mechanism

37 Pivot axis

38 Panel element

40 Hinge

42 Holding element

43 Fluid line

44 Fluid management reservoir

46 Drain line

47 Seal

48 Connector

A Rest position

B Middle position

C Cleaning position

1. A motor vehicle with
a vehicle window,
a vehicle window wiper system for cleaning a field of view of the vehicle window, a vehicle roof which adjoins the vehicle window in a front and/or rear roof region,
an environmental sensor which is arranged in a interior of the motor vehicle in a roof-side corner region of the vehicle window and which can sense a vehicle environment through a transparent region through the vehicle window, and
a cleaning device which is arranged on the vehicle roof and is designed to clean the transparent region of the vehicle window,
wherein the transparent region of the vehicle window is situated at least partially outside the field of view of the vehicle window.

2. The motor vehicle according to claim 1, wherein the cleaning device is arranged from the outside on the vehicle roof and is configured to clean the transparent region of the vehicle window from outside the motor vehicle.

3. The motor vehicle according to claim 1, wherein the environmental sensor is arranged in the interior of the motor vehicle in the corner region behind the vehicle window or directly on the vehicle window or is integrated at least partially into the vehicle window.

4. The motor vehicle according to claim 1, wherein the transparent region of the vehicle window is situated completely outside the field of view of the vehicle window and cannot be cleaned by the vehicle window wiper system.

5. The motor vehicle according to claim 1, wherein the cleaning device has at least one cleaning nozzle which is placed onto the vehicle roof in the roof-side corner region, wherein the at least one cleaning nozzle is oriented onto the transparent region in order to clean the transparent region.

6. The motor vehicle according to claim 1, wherein the cleaning device has at least one cleaning nozzle which can be adjusted in the roof-side corner region from outside the motor vehicle at least between a rest position and a cleaning position, wherein the at least one cleaning nozzle is oriented onto the transparent region in order to clean the transparent region at least in the cleaning position.

7. The motor vehicle according to claim 6, wherein the cleaning device has a drive and an adjusting mechanism, wherein the drive is configured to adjust the at least one cleaning nozzle using the adjusting mechanism at least between the rest position and the cleaning position.

8. The motor vehicle according to claim 7, wherein the adjusting mechanism is designed to tilt the at least one cleaning nozzle, or to move it from the rest position at least into the cleaning position by a complex movement, and/or to adjust it at least partially in front of the transparent region, as viewed in a viewing direction of the environmental sensor.

9. The motor vehicle according to claim 1, wherein the cleaning device has a panel element which is designed to deflect an airstream and/or a headwind of the motor vehicle, in order in this way to increase a cleaning effect of the cleaning device.

10. The motor vehicle according to claim 9, wherein the cleaning device has at least one cleaning nozzle which can be adjusted in the roof-side corner region from outside the motor vehicle at least between a rest position and a cleaning position, wherein the at least one cleaning nozzle is oriented onto the transparent region in order to clean the transparent region at least in the cleaning position, and
wherein the cleaning nozzle is arranged on the panel element and can be adjusted with the panel element at least between the rest position, a middle position and the cleaning position, wherein the at least one cleaning nozzle is designed, furthermore, to clean the transparent region in the middle position.

11. An autonomously driving motor vehicle without a vehicle window wiper system, with
a vehicle window,
a vehicle roof which adjoins the vehicle window in a front and/or rear roof region, an environmental sensor which is arranged in a interior of the motor vehicle in a roof-side corner region of the vehicle window and which can sense a vehicle environment through a transparent region through the vehicle window, and
a cleaning device which is arranged on the vehicle roof and is designed to clean at least the transparent region of the vehicle window.
